(19) United States
(12) Patent Application Publication
(10) Pub. No.: US 2011/0215217 A1
(43) Pub. Date: Sep. 8, 2011

(54) Stands for Mobile Communication Devices

(76) Inventor: Louis De La Garza, Austin, TX (US)

(21) Appl. No.: 12/718,103

(22) Filed: Mar. 5, 2010

(51) Int. Cl. F16M 11/24; F16M 11/22

(52) U.S. Cl. 248/397; 248/176.1

(57) ABSTRACT

Stands for mobile communication devices are provided. In one embodiment, a stand for a mobile communication device includes a backing adapted to at least partially cover a back side of a mobile communication device. The backing has a cutout portion formed by at least one inner edge of the backing. The stand also includes a support flap pivotably coupled to the at least one inner edge of the backing. The support flap is movable between a retracted position and an extended position. The cutout portion of the backing receives the support flap when the support flap is in the retracted position. The support flap is adapted to support the mobile communication device in a standing position when the support flap is in the extended position.

### TECHNICAL FIELD OF THE INVENTION

The illustrative embodiments relate generally to stands, and more particularly, to stands for mobile communication devices.

### BACKGROUND OF THE INVENTION

The use of mobile communication devices, such as cellular phones and mobile computers, has risen sharply in recent decades. With the increased prevalence of mobile communication devices, however, come challenges in the way such devices are physically kept, protected, and used. For example, many current mobile communication devices are unable to stand on a surface, such as a tabletop, due to their shape. Furthermore, many current mobile communication devices are not equipped with any mechanism for standing the device relative to the surface. As a result, users are forced to lay their mobile communication devices flatly against a surface, and are provided no convenient options for orienting the mobile communication device into a standing position.

### SUMMARY OF THE INVENTION

According to an illustrative embodiment, a stand for a mobile communication device includes a backing adapted to at least partially cover a back side of a mobile communication device. The backing has a cutout portion formed by at least one inner edge of the backing. The stand also includes a support flap pivotably coupled to the at least one inner edge of the backing. The support flap is movable between a retracted position and an extended position. The cutout portion of the backing receives the support flap when the support flap is in the retracted position. The support flap is adapted to support the mobile communication device in a standing position when the support flap is in the extended position.

According to another illustrative embodiment, a stand for a mobile communication device includes a backing adapted to at least partially cover a back side of a mobile communication device when the backing is coupled to the mobile communication device. The backing has a cutout portion formed by at least one inner edge of the backing. The stand also includes a backing traction material covering at least one side of the backing. The stand also includes a support flap pivotably coupled to the at least one inner edge of the backing. The support flap is movable between a retracted position and an extended position. The support flap at least partially enters the cutout portion when the support flap is in the retracted position. The support flap is adapted to support the mobile communication device in a standing position when the support flap is in the extended position. The stand also includes a support flap traction material covering at least one edge of the support flap.

According to another illustrative embodiment, a stand for a mobile communication device includes a backing adapted to at least partially cover a back side of a mobile communication device. The backing includes a top inner edge forming a protruding tip and a pin docking notch. The stand also includes a support flap pivotably coupled to the backing. The support flap is movable between a retracted position and an extended position. The support flap is adapted to support the mobile communication device in a standing position when the support flap is in the extended position. The support flap includes a proximal edge comprising a tubular joint. The tubular joint forms a longitudinal hole and comprises a plurality of longitudinal humps on the outer surface of the tubular joint. The plurality of longitudinal humps forms a plurality of longitudinal grooves. The protruding tip is engagable with the plurality of longitudinal grooves. The stand also includes a pin. A first portion of the pin is within the longitudinal hole formed by the tubular joint. A second portion of the pin is within the pin docking notch of the backing. The tubular joint is rotatable around the pin. The support flap is securable into one of the retracted position, the extended position, or an intermediate position between the retracted position and the extended position when the protruding tip is engaged with one of the plurality of longitudinal grooves.

### BRIEF DESCRIPTION OF THE DRAWINGS

FIG. 1 is a schematic, perspective view of a stand in a vertical standing position according to one illustrative embodiment;

FIG. 2 is a schematic, perspective view of the stand in FIG. 1 in a horizontal standing position according to one illustrative embodiment;

FIG. 3 is a schematic, side view of the stand in FIG. 1;

FIG. 4 is a schematic, plan view of the stand in FIG. 1;

FIG. 5 is a schematic, cross-sectional view of the stand in FIG. 4 taken along line 5-5;

FIG. 6 is a schematic, plan view of a portion of a stand having a support flap pivotably coupled to a backing according to one illustrative embodiment;

FIG. 7A is a schematic, cross-sectional view of the pivotal coupling between the support flap and the backing in FIG. 6 taken along line 7A-7A;

FIG. 7B is a schematic, cross-sectional view of the pivotal coupling in FIG. 7A with the support flap in an extended, or intermediate, position;

FIG. 8 is a schematic, cross-sectional view of the support flap and backing in FIG. 6 taken along line 8-8; and

FIG. 9 is a schematic, plan view of a stand according to another illustrative embodiment.

### DETAILED DESCRIPTION OF THE INVENTION

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments are defined only by the appended claims.

Referring to FIGS. 1-5, an illustrative embodiment of a stand 100 for a mobile communication device 102 includes a backing 104, and a support flap 106 pivotably coupled to the backing 104. The support flap 106 is movable between an extended position, as shown in FIGS. 1-3, and a retracted position, as shown in FIG. 4. When the support flap 106 is in the extended position, the support flap 106 supports the mobile communication device 102 in a standing position relative to a surface 108. When the mobile communication device 102 is in the standing position, the mobile communication device 102 is non-parallel with the surface 108, and may form any angle 109 with the surface 108 greater than 0°, and equal to or less than 90°. Thus, a user of the mobile communication device 102 is able to use the stand 100 to support his or her mobile communication device 102 on the surface 108 by moving the support flap 106 into an extended position and positioning the mobile communication device 102 at the angle 109 desired by the user. The stand 100 may also serve as a protective cover for the mobile communication device 102.

As used herein, the term “coupled” includes coupling via a separate object and includes direct coupling. The term “coupled” also encompasses two or more components that are continuous with one another by virtue of each of the components being formed from the same piece of material. Also, the term “coupled” may include chemical, such as via a chemical bond, mechanical, thermal, or electrical coupling.

The mobile communication device 102 may be a cellular phone (e.g., a smart phone), a walkie talkie, a computer (e.g., a laptop, netbook, tablet computer, or minicomputer), a personal digital assistant, a digital music player, a digital reader, a portable gaming device, a web browsing device, a media player, or any other electronic device that is mobile.

The backing 104 at least partially covers the back side 110 of the mobile communication device 102. The backing 104 may be sized or structured to accommodate a wide variety of mobile communication devices 102, depending on the mobile communication device on which the stand 100 is intended to be used. In the non-limiting example of FIGS. 1-5, the mobile communication device 102 is a cellular phone. In addition, the backing 104 may be sized or structured to accommodate different makes or models of cellular phones, such as an iPhone® or other cellular phone made by Apple®, Inc., a Nexus One® or other cellular phone made by Google®, a Droid or other cellular phone made by Motorola®, a BlackBerry° or other cellular phone made by Research in Motion® Limited Corporation, a smartphone made by Samsung®, or any other type, make, or model of cellular phone or smartphone.

In the embodiment of FIGS. 1-5, the backing 104 covers the majority of the back side 110 of the mobile communication device 102. The backing 104 has a top side 112, a first side 114, a second side 116, and a bottom side 118. The backing 104 also includes inner edges that form a cutout portion 120 that receives the support flap 106 when the support flap 106 is in the retracted position. The inner edges that form the cutout portion 120 include a top inner edge 122, a first straight inner edge 124, a second straight inner edge 126, a first tapered inner edge 128, a second tapered inner edge 130, and a bottom inner edge 132. The shape of the cutout portion 120, as defined by the inner edges, substantially, and at least partially, conforms to the shape of the support flap 106 so that the support flap 106 is substantially flush with the back surface 134 of the backing 104 when the support flap 106 is in the retracted position. In other embodiments, the inner edges of the backing 104 may be different in size, number, orientation, or straightness to form different shapes or outlines for the cutout portion 120, and such shape or outline of the cutout portion 120 may depend on the shape or size of the support flap 106.

The backing 104 may be made from any material, soft or rigid, that is able to support the mobile communication device 102 when the stand 100 is in the standing position. In the example of FIGS. 1-5, the backing 104 is a rigid material that snaps onto the back side 110 of the mobile communication device 102. With particular reference to FIG. 5, the first and second sides 114, 116 of the backing 104 form a pocket 136 into which the mobile communication device 102 can be pressed into and secured. In other embodiments, the mobile communication device 102 may be slid into the pocket 136, or the mobile communication device 102 may be coupled to the backing 104 by a different mechanism altogether. In yet another embodiment, the mobile communication device 102 may be permanently or semi-permanently coupled to the backing 104 using such means as glue, latches, screws, etc.

The support flap 106, which is pivotably coupled to the backing 104, may be shaped to substantially conform to the shape of the cutout portion 120. In one embodiment, the support flap 106 tapers toward the terminal resting edge 148. The support flap 106 may include a proximal edge 138, a first straight edge 140, a second straight edge 142, a first tapered resting edge 144, a second tapered resting edge 146, and a terminal resting edge 148. The terminal resting edge 148 may include a user access notch 150. When the support flap 106 is in the retracted position, the user access notch 150 allows a user to grasp, or otherwise move, the support flap 106 out of the retracted position and into an extended position. For example, the user may grasp the support flap 106 at the user access notch 150 using the tip of his or her finger. The user access notch 150 may be substantially semi-circular in shape, or any other shape that allows access by a user. The shape or size of the support flap 106 can vary, and the support flap 106 can be shaped or sized to provide support to the backing 104 and the mobile communication device 102 when the stand 100 is in the standing position.

Any mechanism may be used to pivotably couple the support flap 106 to the backing 104. In the non-limiting example of FIGS. 1-5, the pivoting mechanism includes a tubular joint 152 at the proximal edge 138 of the support flap 106. The tubular joint 152 forms a longitudinal hole 154, which runs substantially through the center of the tubular joint 152. A pin 156 may be inserted, or otherwise included, in the longitudinal hole 154 of the tubular joint 152, and a first end 158 of the pin 156 may be docked in a first pin docking notch 160. A second end 162 of the pin 156 may be docked into a second pin docking notch 164. In this manner, a portion of the pin 156 is within the longitudinal hole 154 of the tubular joint 152, and another portion, in this case the first and second ends 158, 162 of the pin 156, is within the first and second pin docking notches 160, 164, respectively. The tubular joint 152 is rotatable around the pin 156 to allow movement of the support flap 106 between the retracted and extended positions. The pin 156 may be made from metal, or any other material capable of performing the functions of the pin 156 described herein. Other pivoting mechanisms, such as those described below, may also be used to allow movement of the support flap 106 between the retracted and extended positions.

In one embodiment, at least one side of the backing 104 includes a backing traction material 165. In the example of FIGS. 1-5, portions of the top side 112, the first and second sides 114, 116, and the bottom side 118 are covered with the backing traction material 165. In other embodiments, the backing traction material 165 may be provided on the bottom side 118 and either or both of the first and second side 114, 116 of the backing 104. In another embodiment, the backing traction material 165 covers the sides or portions of the backing 104 that are intended to make contact with the surface 108. The backing traction material 165 may be made from any material that provides traction between the backing 104 and the surface 108. Non-limiting examples of the material that may be used for the backing traction material 165 include polymers, such as rubber.

In one embodiment, at least one edge of the support flap 106 includes a support flap traction material 166. In the non-limiting example of FIGS. 1-5, the support flap traction material 166 covers at least a portion of the first and second straight edges 140, 142, the first and second tapered resting edges 144, 146, and the terminal resting edge 148. In another embodiment, the support flap traction material 166 covers the edges or portions of the support flap 106 that are intended to make contact with the surface 108. The support flap traction material 166 may be made from the same or similar material as the backing traction material 165, and provides traction between the support flap 106 and the surface 108. In other embodiments, any side or surface of the backing 104, including the back surface 134 of the backing 104, may be at least partially covered by the backing traction material 165. Similarly, any edge or surface of the support flap 106 may be at least partially covered by the support flap traction material 166. In another embodiment, the material from which the backing 104 or the support flap 106 is made may be the backing traction material 165 or the support flap traction material 166, respectively.

In use, the support flap 106 is movable between the extended position, shown in FIGS. 1-3, and the retracted position, shown in FIG. 4. The support flap 106 forms an angle 167 with the backing 104. When in the retracted position, the angle 167 formed between the support flap 106 and the backing 104 is approximately 0°. The angle 167 between the support flap 106 and the backing 104 when the support flap 106 is in the extended position can be in the range of 1° to 180°. The angle 167 between the backing 104 and the support flap 106 when the support flap 106 is in the extended position is greater than the angle 167 formed between the support flap 106 and the backing 104 when the support flap 106 is in the retracted position.

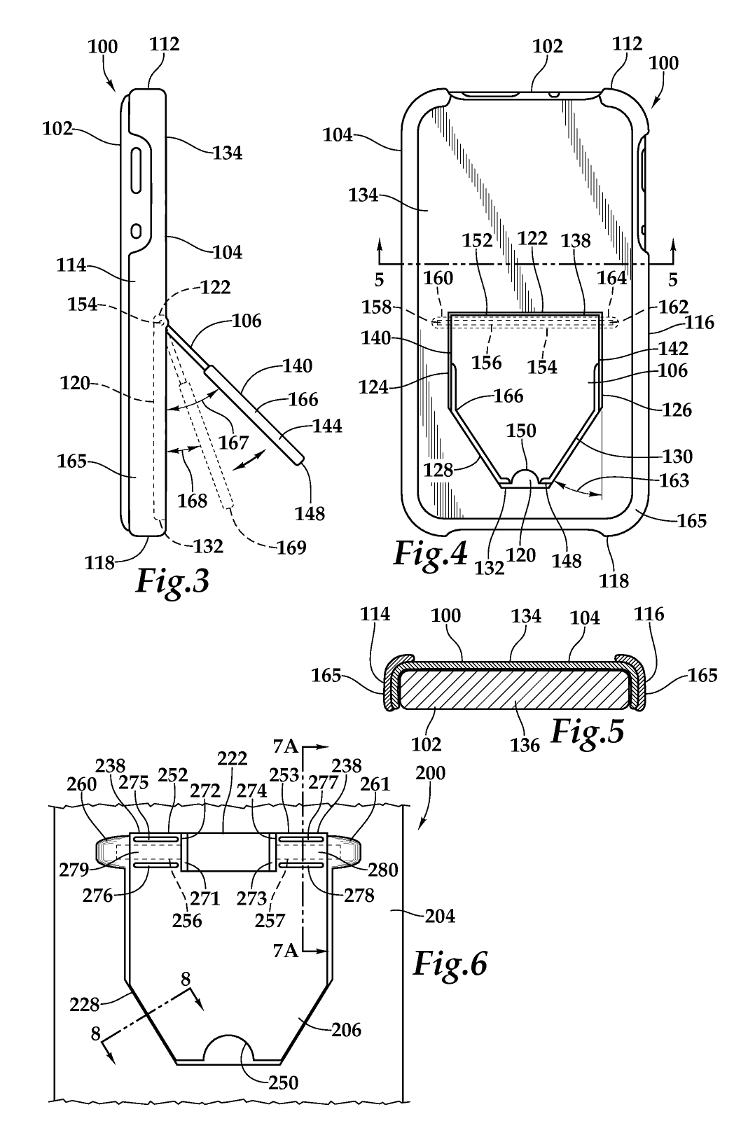

Referring specifically to FIG. 3, the support flap 106 is shown to be in the extended position. As shown in FIG. 3, several intermediate positions, such as the intermediate position 169 represented by an outline of the support flap 106, are possible between the extended position and the retracted position. The support flap 106 may be movable into the extended position, the retracted position, or any one of the intermediate positions 169.

When the support flap 106 is in the intermediate position 169, the angle 168 formed between the support flap 168 and the backing 104 is less than the angle 167 formed by the support flap 106 and the backing 104 when the support flap 106 is in the extended position.

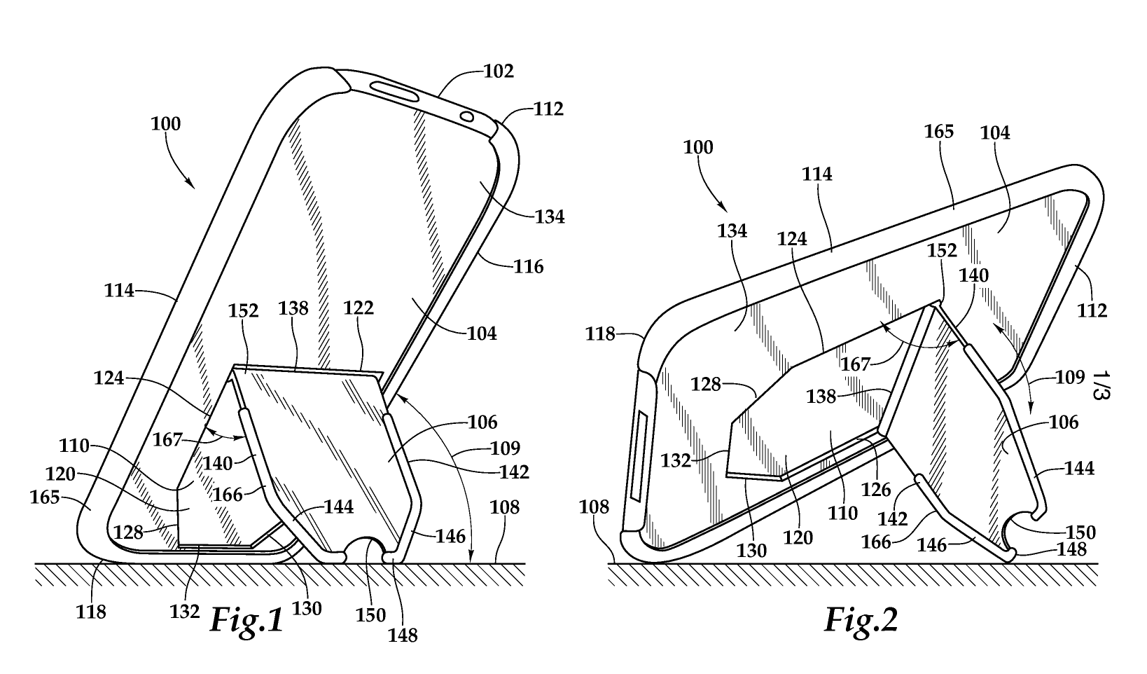

As shown in FIGS. 1 and 2, the stand 100 may be positioned in a vertical standing position, as shown in FIG. 1, or a horizontal standing position, as shown in FIG. 2. Referring specifically to FIG. 1, when the stand 100 is in the vertical standing position, the support flap 106 is in the extended position and the terminal resting edge 148 is resting against the surface 108. The backing traction material 165 and the support flap traction material 166, which cover the bottom side 118 of the backing 104 and the terminal resting edge 148 of the support flap 106, respectively, helps to keep the backing 104 and the support flap 106 from sliding relative to the surface 108. By keeping the backing 104 and the support flap 106 from sliding, the stand 100 may be prevented from falling down or moving into an undesirable position due to an over-extension of the support flap 106. The traction provided by the backing traction material 165 and the support flap traction material 166 also assists a user in positioning the mobile communication device 102 at a desired angle 109 relative to the surface 108. For example, the user may increase or decrease the angle 167 between the support flap 106 and the backing 104 to provide the angle 109 between the mobile communication device 102 and the surface 108 that is desired by the user. The angle 109 at which the user desires to position the mobile communication device 102 can depend on any number of user preferences, such as the angle at which the user desires to view a display of the mobile communication device 102 while the mobile communication device 102 is resting on the surface 108.

Referring specifically to FIG. 2, when the stand 100 is in the horizontal standing position, the support flap 106 is in the extended position and the second tapered resting edge 146 is resting against the surface 108. The horizontal standing position may also be flipped such that the first side 114 of the backing 104 and the first tapered resting edge 144 are in contact with the surface 108. In one embodiment, the angle 167 between the support flap 106 and the backing 104 is greater when the stand 100 is in the horizontal standing position as opposed to the vertical standing position. However, the angle 167 that is used to support the stand 100 in the horizontal standing position may depend on the angle 109 at which the user desires to position the mobile communication device 102 relative to the surface 108. The backing traction material 165 covering the second side 116 of the backing 104, as well as the support flap traction material 166 covering the second tapered resting edge 146 of the support flap 106 are in contact with the surface 108, and help prevent the backing 104 and the support flap 106 from moving, or sliding, relative to the surface 108.

The angle 109 formed between the mobile communication device 102 and the surface 108 may also be varied by changing the angle 163 at which the first and second tapered resting edges 144, 166 taper from the first and second straight edges 140, 142. For example, the angle 163 may be lowered to decrease the taper of the support flap 106. By decreasing the taper of the support flap 106, the angle 109 formed between the mobile communication device 102 and the surface 108 may be increased to provide a more erect horizontal standing position for the mobile communication device 102.

The illustrative embodiments allow a user to erect his or her mobile communication device 102 in a standing position on the surface 108. Furthermore, the illustrative embodiments allow the user to adjust the orientation or the angle 109 of the mobile communication device 102 relative to the surface 108 to satisfy his or her preferences. When the user no longer desires the mobile communication device 102 to be in a standing position, such as when the user desires to transport the mobile communication device 102, the user can move the support flap 106 into the retracted position so that the cutout portion 120 receives the support flap 106. When the support flap 106 is in the retracted position, as shown in the illustrative embodiment of FIGS. 1-5, the first straight edge 140 is adjacent the first straight inner edge 124, the second straight edge 142 is adjacent the second straight inner edge 126, the first tapered resting edge 144 is adjacent the first tapered inner edge 128, the second tapered resting edge 146 is adjacent the second tapered inner edge 130, and the terminal resting edge 148 is adjacent the bottom inner edge 132. When the support flap 106 is in the retracted position, the support flap 106 may be substantially flush with the back surface 134 of the backing 104.

Referring to FIGS. 6, 7A, 7B, and 8, an illustrative embodiment of a pivoting mechanism between the support flap 206 and the backing 204 is shown. Elements of FIGS. 6, 7A, 7B, and 8 that are analogous to elements in FIGS. 1-5 have been shown by indexing the reference numerals by 100. The pivoting mechanism shown in FIGS. 6, 7A, and 7B allow the support flap 206 to be secured, or temporarily locked, into predetermined angles 267 relative to the backing 204.

The proximal edge 238 of the support flap 206 includes a first tubular joint 252 and a second tubular joint 253, each of which form a first longitudinal hole (not shown) and a second longitudinal hole 255, respectively. A first pin docking notch 260 and a second pin docking notch 261 are adjacent the first tubular joint 252 and the second tubular joint 253, respectively. A portion of a first pin 256 is within the longitudinal hole (not shown) of the first tubular joint 252, and a second portion of the first pin 256 is within the first pin docking notch 260. Similarly, a first portion of the second pin 257 is within the longitudinal hole 255 of the second tubular joint 253, and a second portion of the second pin 257 is within the second pin docking notch 261. A first end cap 271 is coupled to an inward-facing end 272 of the first tubular joint 252 to contain the first pin 256 within the first longitudinal hole and the first pin docking notch 260. Similarly, a second end cap 273 is coupled to an inward-facing end 274 of the second tubular joint 253 to contain the second pin 257 within the second longitudinal hole 255 and the second pin docking notch 261. The first and second end caps 271, 273 may be coupled to the inward-facing ends 272, 274 of the first and second tubular joints 252, 253, respectively, using any coupling means, such as gluing, snapping, welding, or other means. The first and second tubular joints 252, 253 are rotatable around the first pin 256 and the second pin 257, respectively, to allow movement of the support flap 206 between retracted and extended positions.

In one embodiment, the outer surface of the first and second tubular joints 252, 253 include a plurality of longitudinal humps 275, 276, 277, 278. The longitudinal humps 275, 276, 277, 278 form a plurality of longitudinal grooves 279, 280. With particular reference to FIGS. 7A and 7B, which shows additional detail regarding the pivoting mechanism adjacent the second tubular joint 253, the second tubular joint 253 includes the longitudinal humps 281, 282, 283, 277, 278, which form the longitudinal grooves 284, 285, 286, 280.

The top inner edge 222 of the backing 204 includes a protruding tip 287 that is engageable with any of the longitudinal grooves 284, 285, 286, 280. When the protruding tip 287 is engaged with the longitudinal groove 284, the support flap 206 is in the retracted position, as shown in FIG. 7A. When the support flap 206 is moved into an extended position, the protruding tip 287 may engage with the longitudinal grooves 285, 287, or 280 to form differing angles 267 between the support flap 206 and the backing 204. By way of specific non-limiting example, the angle 267 may be greater when the protruding tip 287 is engaged with the longitudinal groove 286 than when the protruding tip 287 is engaged with the longitudinal groove 285. Similarly, the angle 267 may be greater when the protruding tip 287 is engaged with the longitudinal groove 280 than when the protruding tip 287 is engaged with the longitudinal groove 286.

The use of the longitudinal grooves 284, 285, 286, 280 as described in this embodiment help to secure, or temporarily lock, the support flap 206 into particular angles and may help prevent the support flap 206 from moving into undesired positions when the stand 200 is in a standing position. For example, the pivoting mechanism described in FIGS. 6, 7A, and 7B may be helpful in keeping the support flap 206 from moving into an over-extended position that results in the toppling, or falling, of the mobile communication device 102 while in the standing position.

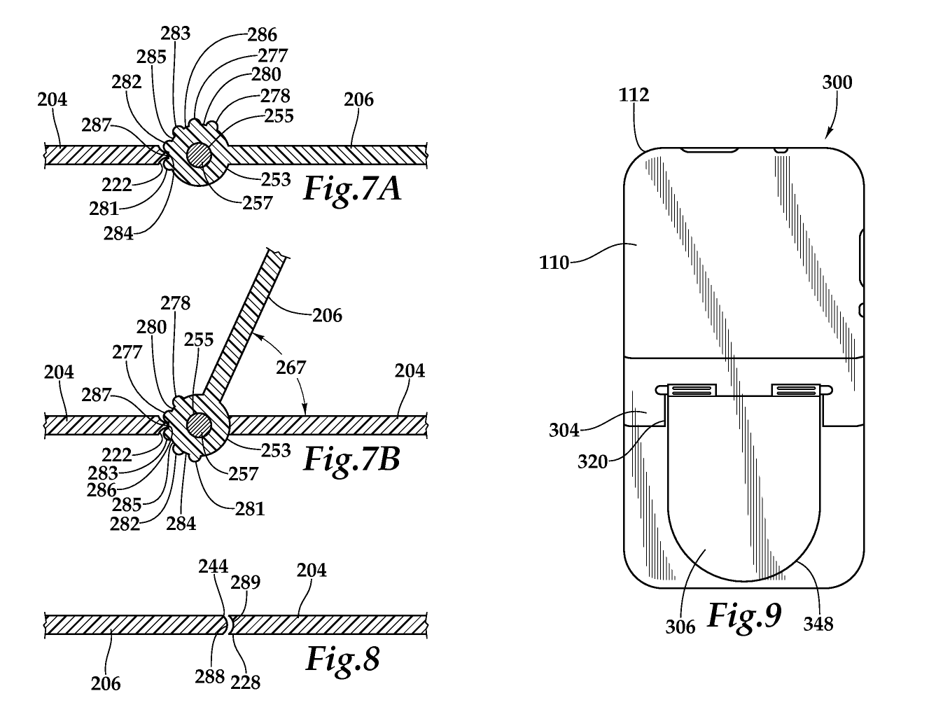

With specific reference to FIG. 8, which shows a cross-sectional view of FIG. 6 taken along line 8-8, the first tapered resting edge 244 of the support flap 206 is shown to be engaged with the first tapered inner edge 228 of the backing 204. The first tapered resting edge 244 is beveled, or otherwise shaped, to form a protruding tip 288. In one embodiment, the protruding tip 288 may approximate a convex, or semicircular, shape. The first tapered inner edge 228 of the backing 204 includes a concave, or otherwise indented, notch 289. When the support flap 206 is in the retracted position, as shown in FIG. 6, the protruding tip 288 of the support flap 206 engages with the notch 289 of the backing 204 to secure the support flap 206 into the retracted position. By securing the support flap 206 in this manner, the support flap 206 may be prevented from inadvertently falling, or otherwise moving, into an extended position. A user may disengage the protruding tip 288 from the notch 289 by, for example, pulling the support flap 206 into the extended position using the user access notch 250.

In another embodiment, the protruding tip 288 may instead be on the first tapered inner edge 228 of the backing 204 and the notch 289 may instead be on the first tapered resting edge 244 of the support flap 206. In other embodiments, any edge of the support flap 206 may be structured to engage with an adjacent inner edge of the backing 204 using the mechanism described in FIG. 8.

In another embodiment, instead of using the plurality of longitudinal humps 281, 282, 283, 277, 278 and grooves 284, 285, 286, 280 described in FIGS. 6, 7A, and 7B, a traction material may be applied to the outer surface of the first and second tubular joints 252, 253 to secure the support flap 206 into particular angles 267 relative to the backing 204. In another embodiment, instead of the pivoting mechanism described in the illustrative embodiments above, a flexible membrane (not shown) may be coupled to the support flap 206 and the backing 204 at the juncture between the proximal edge 238 and the top inner edge 222 to allow movement of the support flap 206 between the extended and retracted positions.

Referring to FIG. 9, another illustrative embodiment of the stand 300 includes the backing 304 and the support flap 306. Elements of FIG. 9 that are analogous to elements in FIGS. 1-5 have been shown by indexing the reference numerals by 200. The backing 304, in contrast to the backing 104 showed in FIGS. 1-5, covers a relatively smaller portion of the back side 110 of the mobile communication device 102. The backing 304 also forms a cutout portion 320 into which the support flap 306 may be received when the support flap 306 is in the retracted position.

Also in this embodiment, the shape of the support flap 306 differs from the support flap 106 shown in FIGS. 1 to 5. In particular, the terminal resting edge 348 of the support flap 306 approximates a semi-circular shape. Such a semi-circular shape may be helpful in supporting the mobile communication device 102 when the stand 300 is in either the vertical standing position or the horizontal standing position. Other types, shapes, sizes, materials, or structures of the backing 304 or the support flap 306 may also be used, which are able to support the mobile communication device 102 in a standing position.

Although the illustrative embodiments described herein have been disclosed in the context of certain illustrative, non-limiting embodiments, it should be understood that various changes, substitutions, permutations, and alterations can be made without departing from the scope of the invention as defined by the appended claims. It will be appreciated that any feature that is described in a connection to any one embodiment may also be applicable to any other embodiment.

What is claimed is:

1. A stand for a mobile communication device, the stand comprising:
a backing adapted to at least partially cover a back side of a mobile communication device, the backing comprising a cutout portion formed by at least one inner edge of the backing; and
a support flap pivotably coupled to the at least one inner edge of the backing, the support flap movable between a retracted position and an extended position, the cutout portion of the backing receiving the support flap when the support flap is in the retracted position, the support flap adapted to support the mobile communication device in a standing position when the support flap is in the extended position.

2. The stand as recited in claim 1, wherein the support flap comprises a tubular joint at a proximal edge of the support flap, the tubular joint comprising a forming a longitudinal hole;
wherein the backing further comprises a pin docking notch;
wherein the stand further comprises a pin, a first portion of the pin within the longitudinal hole formed by the tubular joint, a second portion of the pin within the pin docking notch of the backing; and
wherein the tubular joint is rotatable around the pin to allow movement of the support flap between the retracted position and the extended position.

3. The stand as recited in claim 1, wherein the support flap comprises a tubular joint at a proximal edge of the support flap, the tubular joint forming a longitudinal hole and comprising a plurality of longitudinal humps on the outer surface of the tubular joint, the plurality of longitudinal humps forming a plurality of longitudinal grooves;
wherein the backing further comprises a pin docking notch;
wherein the stand further comprises a pin, a first portion of the pin within the longitudinal hole formed by the tubular joint, a second portion of the pin within the pin docking notch of the backing;
wherein the backing further comprises a top inner edge forming a protruding tip engagable with the plurality of longitudinal grooves;
wherein the tubular joint is rotatable around the pin; and
wherein the support flap is securable into one of the retracted position, the extended position, or an intermediate position between the retracted position and the extended position when the protruding tip is engaged with one of the plurality of longitudinal grooves.

4. The stand as recited in claim 1, wherein the support flap comprises a tubular joint at a proximal edge of the support flap, the tubular joint forming a longitudinal hole and comprising a plurality of longitudinal humps on the outer surface of the tubular joint, the plurality of longitudinal humps forming at least a first longitudinal groove and a second longitudinal groove;
wherein the backing further comprises a pin docking notch;
wherein the stand further comprises a pin, a first portion of the pin within the longitudinal hole formed by the tubular joint, a second portion of the pin within the pin docking notch of the backing;
wherein the backing further comprises a top inner edge forming a protruding tip engagable with the first longitudinal groove and the second longitudinal groove;
wherein the tubular joint is rotatable around the pin;
wherein the support flap forms a first angle with the backing when the protruding tip is engaged with the first longitudinal groove;
wherein the support flap forms a second angle with the backing when the protruding tip is engaged with the second longitudinal groove; and
wherein the second angle is greater than the first angle.

5. The stand as recited in claim 1, wherein the support flap comprises a first tubular joint and a second tubular joint at a proximal edge of the support flap, the first tubular joint forming a first longitudinal hole, the second tubular joint forming a second longitudinal hole;
wherein the backing further comprises a first pin docking notch at a first straight inner edge of the backing;
wherein the backing further comprises a second pin docking notch at a second straight inner edge of the backing;
wherein the stand further comprises a first pin, a first portion of the first pin within the first longitudinal hole formed by the first tubular joint, a second portion of the first pin within the first pin docking notch of the backing;
wherein the stand further comprises a second pin, a first portion of the second pin within the second longitudinal hole formed by the second tubular joint, a second portion of the second pin within the second pin docking notch of the backing;
wherein the stand further comprises a first end cap, the first end cap coupled to an inward-facing end of the first tubular joint to contain the first pin within the first longitudinal hole and the first pin docking notch;
wherein the stand further comprises a second end cap, the second end cap coupled to an inward-facing end of the second tubular joint to contain the second pin within the second longitudinal hole and the second pin docking notch; and
wherein the first and second tubular joints are rotatable around the first and second pins, respectively, to allow movement of the support flap between the retracted position and the extended position.

6. The stand as recited in claim 1, wherein the support flap is movable into a plurality of intermediate positions between the retracted position and the extended position.

7. The stand as recited in claim 1, wherein the support flap comprises a terminal resting edge, a portion of the terminal resting edge forming a user access notch.

8. The stand as recited in claim 1, wherein the backing is snapable to the mobile communication device.

9. The stand as recited in claim 1, wherein the support flap comprises a terminal resting edge adapted to rest against a surface; and
wherein the stand is in a vertical standing position when the support flap is in the extended position and the terminal resting edge is resting against the surface.

10. The stand as recited in claim 1, wherein the support flap comprises a tapered resting edge adapted to rest against a surface; and
wherein the stand is in a horizontal standing position when the support flap is in the extended position and the tapered resting edge is resting against the surface.

11. The stand as recited in claim 1, wherein the support flap comprises a first straight edge, a second straight edge, a first tapered resting edge, a second tapered resting edge, a terminal resting edge, and a proximal edge pivotably coupled to the at least one inner edge of the backing.

12. The stand as recited in claim 1, wherein the at least one inner edge forming the cutout portion of the backing comprises a top inner edge, a first straight inner edge, a second straight inner edge, a first tapered inner edge, a second tapered inner edge, and a bottom inner edge;
wherein the support flap comprises a first straight edge, a second straight edge, a first tapered resting edge, a second tapered resting edge, a terminal resting edge, and a proximal edge, the proximal edge pivotably coupled to the at least one inner edge of the backing; and
wherein, when the support flap is in the retracted position, the first straight edge is adjacent the first straight inner edge, the second straight edge is adjacent the second straight inner edge, the first tapered resting edge is adjacent the first tapered inner edge, the second tapered resting edge is adjacent the second tapered inner edge, and the terminal resting edge is adjacent the bottom inner edge.

13. The stand as recited in claim 1, wherein the cutout portion has a shape that conforms to a shape of the support flap such that the support flap is retractable into the cutout portion when the support flap is in the retracted position.

14. The stand as recited in claim 1, wherein the support flap comprises a terminal resting edge, the support flap tapering toward the terminal resting edge.

15. The stand as recited in claim 1, the support flap comprises at least one edge that forms a protruding tip;
wherein the at least one inner edge comprises an inner edge forming a notch; and
wherein the protruding tip of the support flap engages with the notch when the support flap is in the retracted position.

16. The stand as recited in claim 1, wherein the support flap comprises a tapered resting edge, the tapered resting edge being beveled to form a protruding tip;
wherein the at least one inner edge of the backing comprises a tapered inner edge, the tapered inner edge comprising a concave notch; and
wherein the protruding tip of the tapered resting edge of the support flap engages with the concave notch of the tapered inner edge of the backing when the support flap is in the retracted position.

17. A stand for a mobile communication device, the stand comprising:
a backing adapted to at least partially cover a back side of a mobile communication device when the backing is coupled to the mobile communication device, the backing having a cutout portion formed by at least one inner edge of the backing;
a backing traction material covering at least one side of the backing;
a support flap pivotably coupled to the at least one inner edge of the backing, the support flap movable between a retracted position and an extended position, the support flap at least partially entering the cutout portion when the support flap is in the retracted position, the support flap adapted to support the mobile communication device in a standing position when the support flap is in the extended position; and
a support flap traction material covering at least one edge of the support flap.

18. The stand as recited in claim 17, wherein the backing traction material covers at least a portion of a bottom side, a first side, and a second side of the backing; and
wherein the support flap traction material covers at least a portion of a resting terminal edge, a first tapered resting edge, and a second tapered resting edge of the support flap.

19. The stand as recited in claim 17, wherein the backing is made from the backing traction material; and
wherein the support flap is made from the support flap traction material.

20. A stand for a mobile communication device, the stand comprising:
a backing adapted to at least partially cover a back side of a mobile communication device, the backing comprising a pin docking notch and a top inner edge forming a protruding tip;
a support flap pivotably coupled to the backing, the support flap movable between a retracted position and an extended position, the support flap adapted to support the mobile communication device in a standing position when the support flap is in the extended position, the support flap comprising a proximal edge comprising a tubular joint, the tubular joint forming a longitudinal hole and comprising a plurality of longitudinal humps on the outer surface of the tubular joint, the plurality of longitudinal humps forming a plurality of longitudinal grooves, the protruding tip engagable with the plurality of longitudinal grooves; and
a pin, a first portion of the pin within the longitudinal hole formed by the tubular joint, a second portion of the pin within the pin docking notch of the backing;
wherein the tubular joint is rotatable around the pin; and
wherein the support flap is securable into one of the retracted position, the extended position, or an intermediate position between the retracted position and the extended position when the protruding tip is engaged with one of the plurality of longitudinal grooves.
